(19) United States
(12) Patent Application Publication
(10) Pub. No.: US 2014/0360177 A1
(43) Pub. Date: Dec. 11, 2014

(54) VARIABLE PEDAL FEELING ADJUSTMENT DEVICE

(71) Applicant: Mando Corporation, Pyeongtaek-si (KR)

(72) Inventors: Dong-Yo RYU, Seongnam-si (KR); Young-Song LEE, Ansan-si (KR)

(21) Appl. No.: 14/301,000

(22) Filed: Jun. 10, 2014

(30) Foreign Application Priority Data
Jun. 10, 2013 (KR) 10-2013-0065588

(51) Int. Cl. B60T 13/68; B60T 17/00; G05G 5/03; B60T 7/06

(52) U.S. Cl. CPC B60T 13/686; B60T 7/06; B60T 17/00; G05G 5/03
USPC 60/556

(57) ABSTRACT

Disclosed is a variable pedal feeling adjustment device. A pedal simulator includes a simulator block formed with an oil hole connected to a master cylinder through a passage and a bore communicating with the oil hole, a damping housing slidably installed in the bore while being restricted in rotation, a first reaction unit provided in the bore and configured to provide reaction force by being pressurized by oil from the master cylinder, and a second reaction unit supported by the damping housing and configured to provide reaction force by being pressurized by the first reaction unit. An auxiliary simulator includes an auxiliary chamber connected to the passage through a connection passage, an auxiliary piston slidably provided in the auxiliary chamber, and an auxiliary spring to elastically support the auxiliary piston. A control valve is installed to the connection passage to control transfer of hydraulic pressure to the auxiliary chamber.

### CROSS-REFERENCE TO RELATED APPLICATION

This application claims the benefit of Korean Patent Application No. 2013-0065588, filed on Jun. 10, 2013 in the Korean Intellectual Property Office, the disclosure of which is incorporated herein by reference.

### BACKGROUND

1. Field

Embodiments of the present invention relate to a variable pedal feeling adjustment device, and more particularly to, a variable pedal feeling adjustment device equipped with an additional chamber and capable of adjusting a stroke distance and reaction force (pedal feeling) of a pedal simulator by selectively opening and closing the chamber using a control valve.

2. Description of the Related Art

In general, in order to provide pedal feeling for a driver, a brake system is equipped with a pedal simulator to transfer reaction force to a brake pedal. Such a pedal simulator is configured to be connected to a master cylinder and to be pressurized by hydraulic pressure caused by pedal effort of a brake pedal, thereby transferring reaction force to the brake pedal. A pedal simulator generally includes springs to transfer reaction force to the brake pedal.

For example, such a pedal simulator uses, as disclosed in Korean Patent No. 10-0657576, two springs provided therein as shock absorbing members to absorb shock to a simulator piston. However, the two springs merely produce brake pedal feeling linearly varying along the straight lines and may not provide required pedal feeling.

Further, because the springs have the limited performance in providing reaction force, the conventional pedal simulator may not adjust pedal feeling that a driver receives.

### CITATION LIST

### Patent Literature

Korean Patent Registration No. 10-0657576 (Registration Date: Dec. 7, 2006)

### SUMMARY

It is an aspect of the present invention to provide a variable pedal feeling adjustment device equipped with an additional chamber and capable of adjusting a pedal stroke distance and reaction force of a pedal simulator configured to provide pedal feeling by selectively opening and closing the chamber.

It is another aspect of the present invention to provide a variable pedal feeling adjustment device capable of improving pedal feeling by preventing sudden increase in pedal effort and providing soft pedal feeling through sequential supply of reaction force using two springs and two damping members.

Additional aspects of the invention will be set forth in part in the description which follows and, in part, will be obvious from the description, or may be learned by practice of the invention.

In accordance with one aspect of the present invention, a variable pedal feeling adjustment device to adjust a pedal feeling provided for a driver by hydraulic pressure caused by pedal effort of a driver comprises: a pedal simulator including a simulator block formed with an oil hole at an upper portion thereof and a bore therein, the oil hole being connected to a master cylinder through a passage to receive hydraulic pressure caused by pedal effort of a driver and the bore communicating with the oil hole, a damping housing slidably installed to a lower portion of the bore to seal a lower end portion of the bore while being restricted in rotation, a first reaction unit provided in the bore and configured to provide reaction force by being pressurized by oil supplied from the master cylinder, and a second reaction unit supported by the damping housing and configured to provide reaction force by being compressed by pressurization of the first reaction unit; an auxiliary simulator including an auxiliary chamber connected to the passage through a connection passage, an auxiliary piston slidably provided in the auxiliary chamber, and an auxiliary spring to elastically support the auxiliary piston; and a control valve installed to the connection passage to control transfer of hydraulic pressure to the auxiliary chamber.

The control valve may be a normally closed type solenoid valve which is normally kept closed but which is opened by control.

The first reaction unit may include: a first reaction piston slidably installed in the bore; a first damping member installed to the first reaction piston to move together therewith; and a first reaction spring configured to be compressed by the first reaction piston.

The first reaction piston may have an insertion recess which is concavely formed at a lower end portion of the first reaction piston and extends upward and into which the first damping member is inserted, and the insertion recess may be provided with a stepped portion by which an upper end of the first reaction spring is supported.

The second reaction unit may include: a second reaction piston slidably provided in the bore and spaced a certain distance apart from the first reaction piston to support the first reaction spring; a second reaction spring installed between the second reaction piston and the damping housing and configured to be compressed by the second reaction piston; and a second damping member installed in the damping housing and configured to be elastically deformed by being pressurized by the second reaction piston.

The second reaction piston may include: a protruding portion protruding toward the first damping member and spaced a certain distance apart from the first damping member; and an extending portion extending radially outward from a lower end of the protruding portion. The protruding portion may be inserted into the first reaction spring and a lower end of the first reaction spring may be supported by the extending portion.

The first damping member and the second damping member may be made of rubber which is elastically deformable.

The damping housing may include: a body portion which is spaced a certain distance apart from the second reaction piston and is formed in a cylindrical shape having an opened top surface and an accommodation space therein; and a flange portion which extends radially from a lower outer peripheral surface of the body portion and is assembled to the bore.

The flange portion may be formed with a support recess at a top surface thereof to support the second reaction spring.

The first reaction spring may have a smaller modulus of elasticity than the second reaction spring so that the first reaction piston is pushed to allow the first damping member to contact the second reaction piston to provide reaction force and the second reaction piston is pushed and pressurizes the second damping member so that the second damping member provides reaction force.

The damping housing may be provided with a cap at a lower end portion thereof to fix the damping housing to the simulator block.

As is apparent from the above description, the variable pedal feeling adjustment device is equipped with an additional auxiliary chamber and provides required pedal feeling for a driver by adjusting a stroke distance and reaction force of the pedal simulator by controlling transfer of hydraulic pressure caused by pedal effort of a pedal to the chamber using the control valve.

Further, since reaction force is sequentially supplied using two reaction springs and two damping members, sudden increase in pedal effort is prevented and soft pedal feeling is provided, thereby improving pedal feeling.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view illustrating a variable pedal feeling adjustment device according to an exemplary embodiment of the present invention;

FIGS. 2 and 3 are views illustrating operation of a pedal simulator of the variable pedal feeling adjustment device according to an exemplary embodiment of the present invention;

FIG. 4 is a view illustrating operation of an auxiliary simulator of the variable pedal feeling adjustment device according to an exemplary embodiment of the present invention; and

FIG. 5 is a graph illustrating a relationship between a pedal stroke by the variable pedal feeling adjustment device and pedal feeling according to an exemplary embodiment of the present invention.

### DETAILED DESCRIPTION

Now, preferred embodiments of the present invention will be described in detail with reference to the annexed drawings.

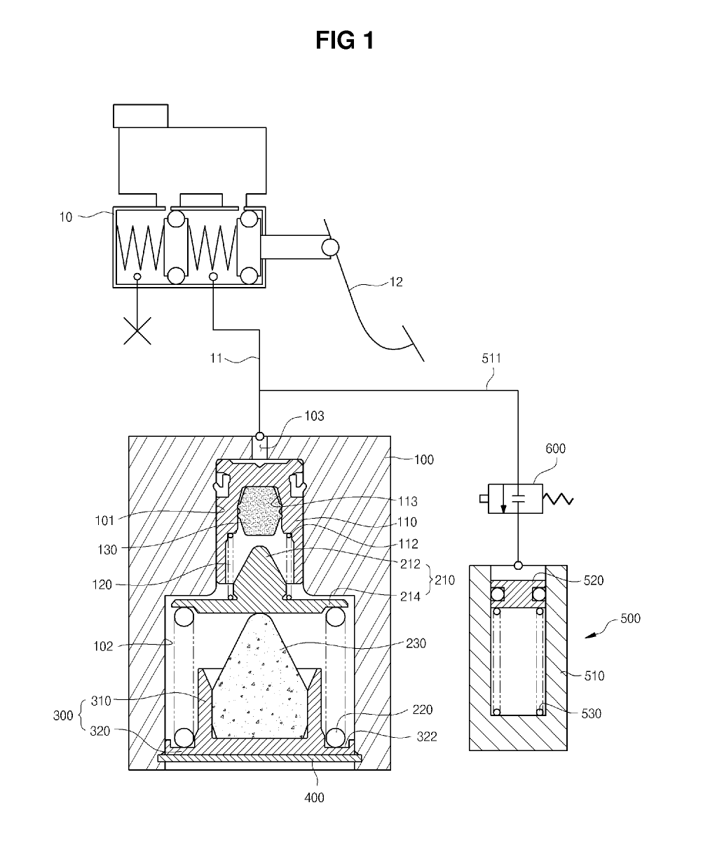

FIG. 1 is a view illustrating a variable pedal feeling adjustment device according to an exemplary embodiment of the present invention.

As shown in FIG. 1, a variable pedal feeling adjustment device according to an exemplary embodiment of the present invention comprises a pedal simulator 100 to provide pedal feeling for a driver, an auxiliary simulator 500 connected to a passage 11 through which hydraulic pressure is transferred to the pedal simulator 100, and a control valve 600 to control transfer of hydraulic pressure to the auxiliary simulator 500.

The pedal simulator 100 includes a simulator block 100′ connected to a master cylinder 10 which is configured to produce hydraulic brake pressure by a brake pedal 12 to accommodate oil from the master cylinder 10 therein, a first reaction unit and a second reaction unit installed to the simulator block 100′ to provide pedal feeling, and a damping housing 300 configured to support the second reaction unit and seal a lower end portion of a bore. The first reaction unit and the second reaction unit are provided in a bore formed in the simulator block 100′ and arranged in series.

The simulator block 100′ is formed with an oil hole 103 at an upper portion thereof to allow inflow of hydraulic pressure from the master cylinder 10 and a bore communicating with the oil hole 103. The oil hole 103 is connected to the master cylinder 10 through the passage 11. The bore formed in the simulator block 100′ includes a first bore 101 in which the first reaction unit is disposed, and a second bore 102 in which the second reaction unit is disposed. Referring to FIG. 1, the first bore 101 has a smaller diameter than the second bore 102. Thereby, the bore has a stepped shape. The first bore 101 and the second bore 102 respectively have diameters corresponding to a first reaction piston 110 of the first reaction unit and a second reaction piston 210 of the second reaction unit which will be described later. Therefore, depending on diameters of the reaction pistons 110 and 210, the diameters of the first and second bores may be changed and pedal feeling may be adjusted.

The first reaction unit includes a first reaction piston 110 slidably installed in the first bore 101, a first damping member 130 installed to move together with the first reaction piston 110, and a first reaction spring 120 configured to be compressed by the first reaction piston 110.

When hydraulic pressure is introduced through the oil hole 103 located above the first reaction piston 110, the first reaction piston 110 moves downward. Herein, an insertion recess 113 is concavely formed at a lower end portion of the first reaction piston 110 and extends upward. The insertion recess 113 is provided with a stepped portion 112, a diameter of which is decreased from the lower end portion to the upper end portion of the first reaction piston 110. The first damping member 130 is inserted into the insertion recess 113 and is located above the stepped portion 112, and the upper end of the first reaction spring 120 is supported by the stepped portion 112. Therefore, the first damping member 130 moves together with the first reaction piston 110, and the first reaction spring 120 provides reaction force during movement of the first reaction piston 110.

The first reaction spring 120 is formed in a coil shape to supply reaction force to the brake pedal 12. Herein, the lower end of the first reaction spring 120 is supported by a second reaction piston 210 which will be described later.

The first damping member 130 is made of rubber which is elastically deformable. The first damping member 130 functions to supply reaction force to the brake pedal 12 when contacted and pressurized by the second reaction piston 210.

The second reaction unit includes a second reaction piston 210 provided in the second bore 102 to slide, a second reaction spring 220 installed between the second reaction piston 210 and the damping housing 300 to be compressed by the second reaction piston 210, and a second damping member 230 installed in the damping housing 300 to be supported thereby.

The second reaction piston 210 is spaced a certain distance apart from the first reaction piston 110 to support the lower end of the first reaction spring 120. More specifically, the second reaction piston 210 includes a protruding portion 212 provided at a position opposite to the insertion recess 113 and protruding toward the first damping member 130, and an extending portion 214 extending radially outward from a lower end of the protruding portion 212.

As shown in the drawings, the protruding portion 212 protrudes toward the first bore 101. Thereby, the protruding portion 212 is positioned in the first reaction piston 110 and spaced a certain distance apart from the first damping member 130. Herein, the protruding portion 212 is arranged to be inserted into the first reaction spring 120 to allow the lower end of the first reaction spring 120 to be supported by the extending portion 214.

The extending portion 214 is disposed in the second bore 102 and functions to support the lower end of the first reaction spring 120 and the upper end of the second reaction spring 220. Herein, the extending portion 214 is configured to pressurize the second damping member 230 positioned therebelow. Accordingly, a bottom surface of the extending portion 214 may have a flat shape.

The second reaction spring 220 is formed in a coil shape to supply reaction force to the brake pedal 12. That is, when the second reaction piston 210 moves, the second reaction spring 220 is compressed to supply reaction force. Herein, the modulus of elasticity of the second reaction spring 220 is greater than that of the first reaction spring 120. Thereby, the second reaction piston 210 is pushed after the first reaction piston 110 is pushed.

The second damping member 230 is made of rubber which is elastically deformable. The second damping member 230 functions to supply reaction force to the brake pedal 12 when contacted and pressurized by the second reaction piston 210. The second damping member 230 is installed in the damping housing 300. Although it is illustrated that the upper end of the second damping member 230 installed in the damping housing 300 is in contact with the second reaction piston 210, the embodiments are not limited thereto. It may be constituted that the second reaction piston 210 comes into contact with the second damping member 230 after moving a certain distance down.

The damping housing 300 is assembled to the simulator block 100′ and is spaced a certain distance apart from the second reaction piston 210. As described above, the damping housing 300 is assembled to the lower end portion of the second bore 102 and is spaced a certain distance apart from the second reaction piston 210. More specifically, the damping housing 300 includes a body portion 310 which is formed in a cylindrical shape having an opened top surface and a flange portion 320 which extends radially from a lower outer peripheral surface of the body portion 310.

The body portion 310 has an accommodation space therein, and the second damping member 230 is installed in the accommodation space of the body portion 310. Herein, an upper inner surface of the body portion 310 may extend upward while being inclined outward so that the second damping member 230 is easily elastic-deformed.

The flange portion 320 is assembled to a lower end portion of the second bore 102, and is formed with a support recess 322 at a top surface thereof to support the second reaction spring 220. The body portion 310 and the flange portion 320 are formed integrally with each other.

A cap 400 is installed to a lower end portion of the damping housing 300 so that the damping housing 300 is stably fixed to the simulator block 100′. In other words, the cap 400 is fixed to the simulator block 100′, to thereby support the damping housing 300.

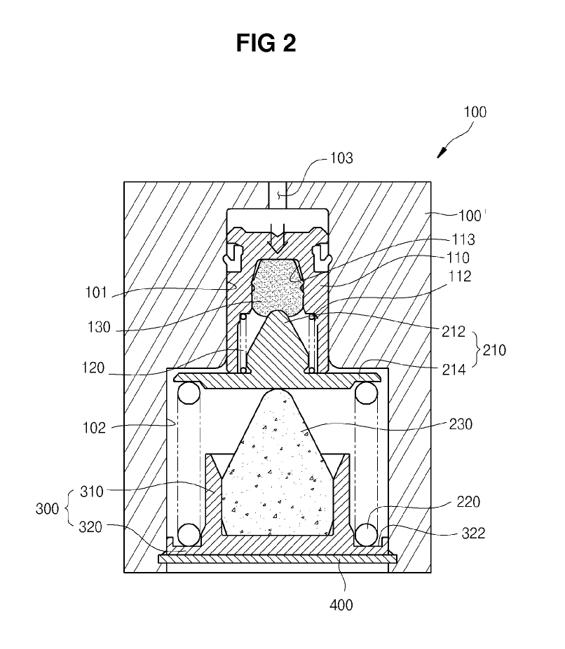

The pedal simulator 100 includes the two reaction springs 120 and 220 and the two damping members 130 and 230 and functions to provide pedal feeling sequentially by the first reaction unit and the second reaction unit. More specifically, as shown in FIG. 2, when hydraulic pressure from the master cylinder (see ‘10’ in FIG. 1) is introduced through the oil hole 103 of the simulator block 100′, the first reaction piston 110 is pushed to compress the first reaction spring 120. Thereby, reaction force is produced. In addition, the first damping member 130 installed at the first reaction piston 110 is also moved and pressurized by the second reaction piston 210 to produce reaction force.

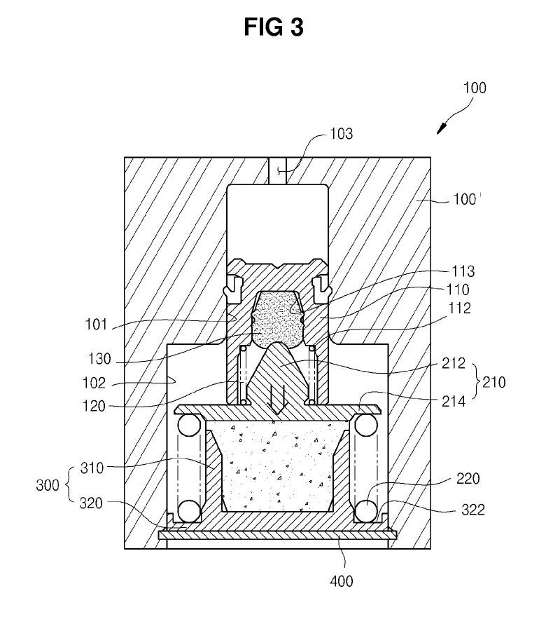

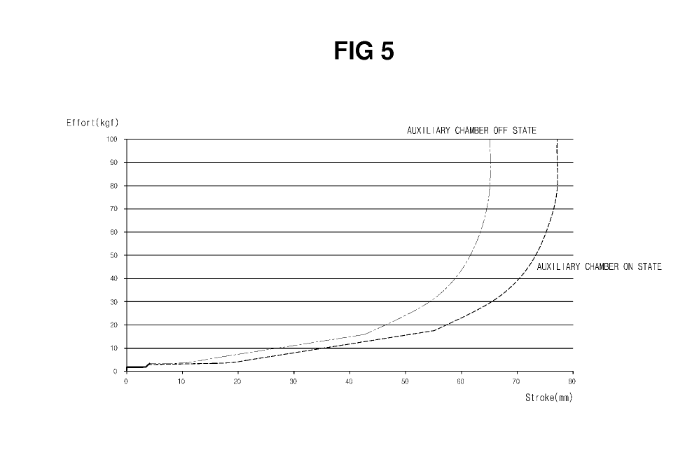

Subsequently, as shown in FIG. 3, as the first reaction piston 110 is moved and the lower end thereof contacts the second reaction piston 210, the second reaction piston 210 is pushed and the second reaction spring 220 is compressed to produce reaction force. At this time, as the second reaction piston 210 contacts and pressurizes the second damping member 230 positioned therebelow, the second damping member 230 is pressurized to produce reaction force. At this time, the reaction force transferred to a driver by the second reaction unit corresponds to a combination of reaction force of the first reaction unit and reaction force of the second reaction unit. In other words, reaction force of the first reaction unit and reaction force of the second reaction unit are combined sequentially and transferred to a driver in a quadratic curve shape, which is similar to reaction force produced by a pedal simulator of a conventional brake system (CBS), thereby providing a driver with good pedal feeling (refer to FIG. 5).

In order to adjust a pedal stroke distance and pedal feeling provided through the pedal simulator 100, the variable pedal feeling adjustment device of the present invention further includes an auxiliary simulator 500 and a control valve 600 to control transfer of hydraulic pressure to the auxiliary simulator 500.

The auxiliary simulator 500 includes an auxiliary chamber 510 connected to the passage 11 connected to the oil hole 103 through a connection passage 511, an auxiliary piston 520 slidably provided in the auxiliary chamber 510, and an auxiliary spring 530 provided in the auxiliary chamber 510 to elastically support the auxiliary piston 520.

The control valve 600 is installed to the connection passage 511 and functions to control transfer of hydraulic pressure to the auxiliary chamber 510. For example, the control valve 600 may be a normally closed type (NC type) solenoid valve which is normally kept closed but which is opened by control. The control valve 600 is opened or closed through driver's selective manipulation of a manipulation switch (not shown), thereby controlling transfer of hydraulic pressure to the auxiliary chamber 510.

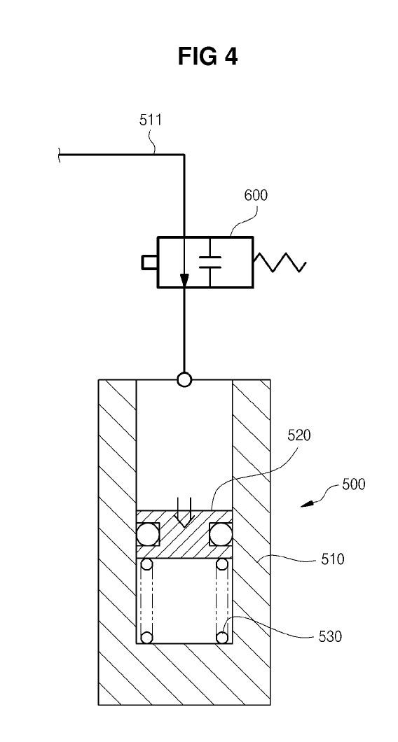

As shown in FIG. 4, the auxiliary simulator 500 provides a driver with reaction force generated when the auxiliary piston 520 is pressed by hydraulic pressure transferred through the connection passage 511 to compress the auxiliary spring 530. Depending on opening or closing of the control valve 600, pedal feeling is adjusted, and stroke distances of the reaction pistons 110 and 210 of the pedal simulator 100 are changed. Referring to FIGS. 4 and 5, when the control valve 600 is opened, hydraulic pressure caused by pedal effort of the brake pedal (see ‘12’ in FIG. 1) is distributed to the pedal simulator 100 and the auxiliary simulator 500. Accordingly, the pedal stroke distance becomes longer and pedal feeling becomes softer than the state in which the control valve 600 is kept closed. In other words, a driver may receive “soft” pedal feeling through opening of the connection passage 511, or may receive “hard” pedal feeling through closing of the connection passage 511.

As a result, the variable pedal feeling adjustment device according to an exemplary embodiment of the present invention includes an additional auxiliary simulator 500 and controls transfer of hydraulic pressure to the auxiliary simulator 500 using the control valve 600, thereby providing required pedal feeling for a driver.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A variable pedal feeling adjustment device to adjust a pedal feeling provided for a driver by hydraulic pressure caused by pedal effort of a driver, comprising:
a pedal simulator including a simulator block formed with an oil hole at an upper portion thereof and a bore therein, the oil hole being connected to a master cylinder through a passage to receive hydraulic pressure caused by pedal effort of a driver and the bore communicating with the oil hole, a damping housing slidably installed to a lower portion of the bore to seal a lower end portion of the bore while being restricted in rotation, a first reaction unit provided in the bore and configured to provide reaction force by being pressurized by oil supplied from the master cylinder, and a second reaction unit supported by the damping housing and configured to provide reaction force by being compressed by pressurization of the first reaction unit;
an auxiliary simulator including an auxiliary chamber connected to the passage through a connection passage, an auxiliary piston slidably provided in the auxiliary chamber, and an auxiliary spring to elastically support the auxiliary piston; and
a control valve installed to the connection passage to control transfer of hydraulic pressure to the auxiliary chamber.

2. The variable pedal feeling adjustment device according to claim 1, wherein the control valve is a normally closed type solenoid valve which is normally kept closed but which is opened by control.

3. The variable pedal feeling adjustment device according to claim 1, wherein the first reaction unit includes:
a first reaction piston slidably installed in the bore;
a first damping member installed to the first reaction piston to move together therewith; and
a first reaction spring configured to be compressed by the first reaction piston.

4. The variable pedal feeling adjustment device according to claim 3, wherein the first reaction piston has an insertion recess which is concavely formed at a lower end portion of the first reaction piston and extends upward and into which the first damping member is inserted,
and wherein the insertion recess is provided with a stepped portion by which an upper end of the first reaction spring is supported.

5. The variable pedal feeling adjustment device according to claim 3, wherein the second reaction unit includes:
a second reaction piston slidably provided in the bore and spaced a certain distance apart from the first reaction piston to support the first reaction spring;
a second reaction spring installed between the second reaction piston and the damping housing and configured to be compressed by the second reaction piston; and
a second damping member installed in the damping housing and configured to be elastically deformed by being pressurized by the second reaction piston.

6. The variable pedal feeling adjustment device according to claim 5, wherein the second reaction piston includes:
a protruding portion protruding toward the first damping member and spaced a certain distance apart from the first damping member; and
an extending portion extending radially outward from a lower end of the protruding portion,
and wherein the protruding portion is inserted into the first reaction spring and a lower end of the first reaction spring is supported by the extending portion.

7. The variable pedal feeling adjustment device according to claim 5, wherein the first damping member and the second damping member are made of rubber which is elastically deformable.

8. The variable pedal feeling adjustment device according to claim 5, wherein the damping housing includes:
a body portion which is spaced a certain distance apart from the second reaction piston and is formed in a cylindrical shape having an opened top surface and an accommodation space therein; and
a flange portion which extends radially from a lower outer peripheral surface of the body portion and is assembled to the bore.

9. The variable pedal feeling adjustment device according to claim 8, wherein the flange portion is formed with a support recess at a top surface thereof to support the second reaction spring.

10. The variable pedal feeling adjustment device according to claim 5, wherein the first reaction spring has a smaller modulus of elasticity than the second reaction spring so that the first reaction piston is pushed to allow the first damping member to contact the second reaction piston to provide reaction force and the second reaction piston is pushed and pressurizes the second damping member so that the second damping member provides reaction force.

11. The variable pedal feeling adjustment device according to claim 1, wherein the damping housing is provided with a cap at a lower end portion thereof to fix the damping housing to the simulator block.
